(19) United States
(12) Patent Application Publication
(10) Pub. No.: US 2016/0262366 A1
(43) Pub. Date: Sep. 15, 2016

(54) GLUE TRAP APPARATUS

(71) Applicant: LEONARD ROLA, BEACON, NY (US)

(72) Inventor: LEONARD ROLA, BEACON, NY (US)

(21) Appl. No.: 15/007,516

(22) Filed: Jan. 27, 2016

Related U.S. Application Data
(60) Provisional application No. 62/130,010, filed on Mar. 9, 2015.

(51) Int. Cl. A01M 1/14

(52) U.S. Cl. CPC A01M 1/14

(57) ABSTRACT

A glue trap device is provided for trapping for example bugs. The device comprises a plurality of sheets of adhesive material that include an enlarged area with a central opening therethrough. The central opening is adapted to receive a furniture post therethrough while the enlarged area of the device surrounds the post along the floor or other surface. The device includes a stack of removable adhesive sheets for catching for example bed bugs that attempt to reach the bedpost. The sheets surround the furniture post and catch bugs attempting to crawl onto the furniture post to access the furniture. A used sheet can be peeled off to reveal a clean sheet thereunder.

### CROSS-REFERENCE TO RELATED APPLICATION

This application claims benefit under 35 U.S.C. §119(e) of U.S. Provisional Application Ser. No. 62/130,010 filed Mar. 9, 2015, which is hereby incorporated by reference herein in its entirety

### FIELD

The subject disclosure relates to pest control, and more particularly, to a glue apparatus for trapping pests.

### BACKGROUND

Pests are well known for overwhelming one's habitat or business with infestation once left unchecked. Moreover, some pests are notorious for hiding in and inhabiting articles which are used daily by the person. The pests access for example, one's furniture such as beds or couches and hide in crevices making detection difficult.

For example, bed bugs are very difficult to get rid of because they are hard to find and kill. During the nighttime, bed bugs come out from hiding and bite people as they sleep. Bed bugs may also migrate climbing up structures, for example, furniture posts touching the floor, into other places to nest such as one's clothing storage, taking up residence in one's clothes. Unwittingly, one may then carry one or more of the pests to another locale spreading the nuisance thereto.

Some methods of removal include spray pesticides or bug bombs, but unfortunately pesticides of this type may not be completely effective since the spray may not reach areas in which the bug hides and can be dangerous if used improperly.

Devices exist in the art related to insect traps and glue traps. These include those with a confinement area in which a replaceable glue pad is positioned. Others provide a glue trap formed as an enclosed paperboard receptacle with adhesive on the walls thereof. Prior art devices are generally placed adjacent a floor/wall interface anticipating pests will travel along the perimeter edges of a room. Devices as described above are easily circumvented and are especially avoided when placed near furniture posts.

As can be seen, there is a need for a device that can trap pests as they attempt to climb up furniture posts.

### SUMMARY

In one aspect of the disclosure, a glue trap comprises a sheet including a layer of adhesive on an upper surface of the sheet for trapping pests coming into contact with the adhesive. A central opening in the sheet is adapted to receive a furniture post within the central opening. Pests will be trapped as they attempt to access the furniture post.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a front view of a glue trap system in packaging in accordance with an aspect of the subject technology.

FIG. 2 is a perspective top view of a glue trap in use around the base of a furniture post in accordance with an aspect of the subject technology.

FIG. 3 is a perspective top view of the glue trap of FIG. 3 showing a used top sheet peeled away from underlying sheets.

FIG. 4 a perspective view of the glue trap of FIG. 2 in use around the base of multiple pieces of furniture.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, exemplary embodiments of the subject technology provide a glue trap for capturing and killing insects attempting to crawl up furniture. Specifically, a furniture post glue trap mat is disclosed that traps bugs as they attempt to access the upright posts of furniture, thereby trapping the bugs and preventing them from making entry onto furniture and into a bed.

Overall, the present invention is effective for capturing bugs as they attempt to gain access to furniture items. This is useful for indoor and outdoor furniture, as well as for treating bedbugs around bed posts. The disclosed glue trap eliminates the need for harsh bug repellants and dangerous chemicals. The device is designed with a central opening adapted to accommodate a post of a furniture article therethrough, whereby the device is positioned around posts or legs. Over time, the user peels away adhesive layers to reveal a fresh layer when needed.

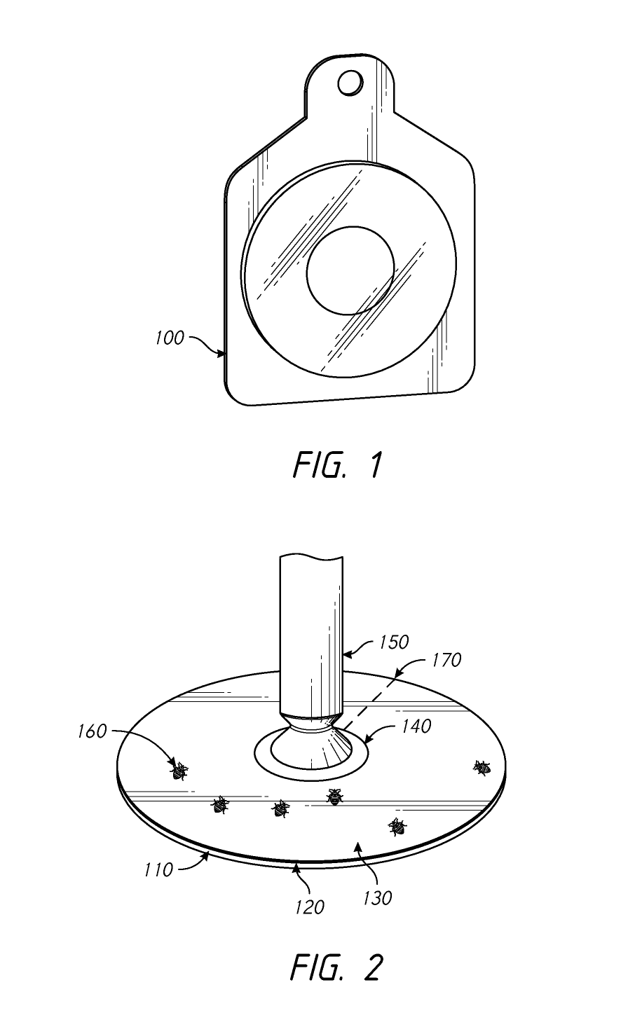

Referring now to FIGS. 1 and, there is shown an exemplary embodiment of a glue trap 110 in its packaging 100 and in use. The glue trap 110 may include a layer 120 of glue or adhesive on an exposed surface of a sheet 130. The glue trap 110 includes a central opening 140 adapted to surround a furniture post 150 resting on the floor. For example, the central opening 140 may be approximately 2.5 cm or larger. The central opening 140 provides an open area for the furniture post 150 so that the post 150 is not necessarily exposed to any glue or adhesive. In an exemplary embodiment, the sheet 130 may be disc-shaped or circular and sized to be larger than a majority of pests 160 (for example, insects). The distance from an outer edge of the sheet 130 to the edge of the central opening 140 may be in the range of 2.5 cm to 10.0 cm. Thus a pest 160 would need to contact the layer 120 in order to reach the furniture post 150. In operation, as a pest 160 would travel over the exposed surface of the sheet 130 getting caught by the layer 120.

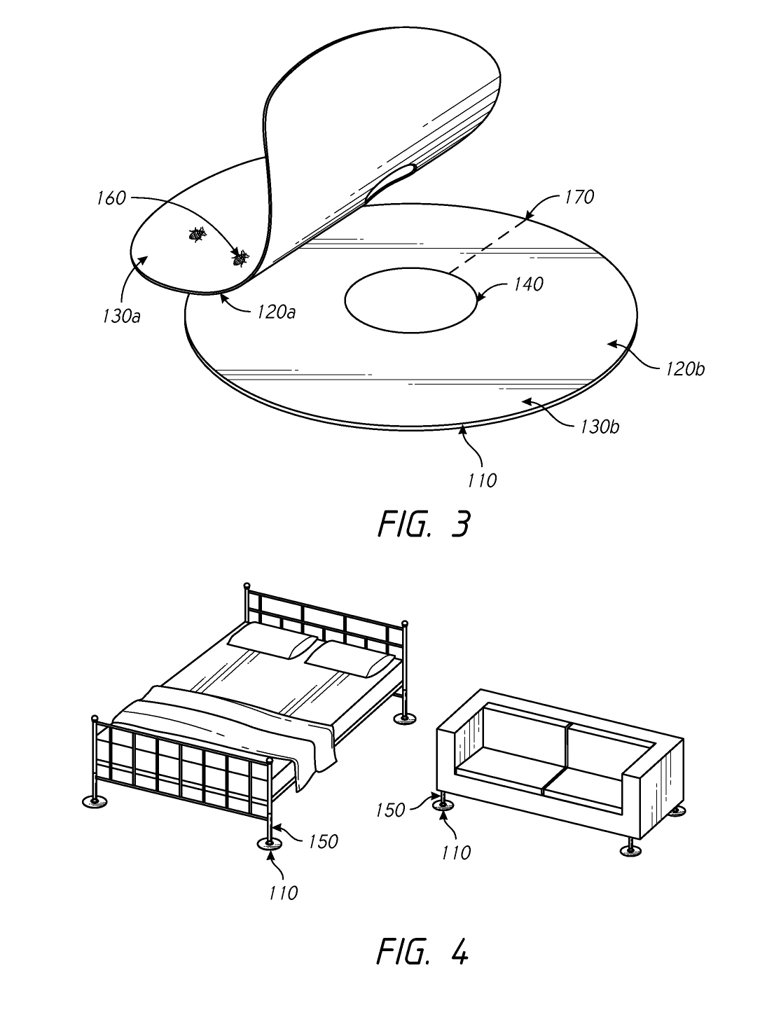

Referring now to FIGS. 2 and 3, an exemplary embodiment of the glue trap 100 comprises a plurality of sheets 130 (sheets 130a and 130b) with respective adhesive surface layers 120a and 120b stacked on one another. The adhesive on surface layers 120a and 120b may be of sufficient adhesion to immobilize pests 150 such as insects and yet be tacky enough to allow the sheet 130a to be separated from the sheet 130b by manual force from a user. The central opening 140 may extend through the stack of sheets 130. Each sheet 130 is removable from the next by peeling away the topmost sheet 130. Some embodiments may include a series of perforations or a slit 170 extending from the central opening 140 to an outer edge of the sheet 130.

As shown in FIG. 3, once pests 160 are trapped by layer 120a, the exposed sheet 130a is peeled away from sheet 130b exposing a fresh unused surface layer 120b for trapping additional pests 160. In this way, the furniture post 150 is positioned through the central opening 140 and the adhesive is disposed around its periphery on the ground surface. As bugs attempt to gain access to the furniture post, the adhesive traps the bugs on the surface, preventing their access to the furniture item.

Each sheet 130 may adhere to the underlying sheet 130 by the adhesive layer 120 until peeled away, thereby allowing the upper adhesive layer 120 to remain tacky after periods of time. The upper adhesive layer 120 may become filled with pests 160 or simply lose tackiness after a period of dust accumulation. Therefore, each sheet 130 is peelable to reveal a fresh layer 120 of adhesive for extended use of one glue trap 110 around the furniture post 150. The user may tear the used sheet 130a along the series of perforations 170 and pull the sheet 130a from around the furniture post 150 without the need to lift furniture.

Referring now to FIG. 4, the glue trap 110 may be positioned around multiple furniture posts 150 for multiple pieces of furniture. The glue trap 100 is suitable for indoor and outdoor use, and may be primarily designed for use in conjunction with bed posts and other furniture posts 150. The central opening 140 is a position upon which furniture posts 150 and other furniture legs can be placed. As bugs and other pests 160 swarm the furniture and try to climb up the posts 150, they will stick to the exposed adhesive on layer 120 and eventually die. Users can peel away the top sheet 130 as needed to reveal a fresh, clean layer beneath it, thus providing a system protecting each piece of furniture from being infested by the most easily accessible path; the floor. As may be appreciated, the glue trap 110 is easy to position, provides a low profile around furniture, and easy to maintain with its peelable sheets 130 that are quickly replaced on convenience.

Those of skill in the art would appreciate that various components and blocks may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A glue trap, comprising:
a sheet including a layer of adhesive on an upper surface of the sheet; and
a central opening in the sheet adapted to receive a furniture post within the central opening.

2. The glue trap of claim 1, further comprising a plurality of the sheet including the layer of adhesive, the plurality of the sheet arranged in a stack of sheets; and
wherein the adhesive comprises a tackiness that is strong enough to hold adjacent sheets in the stack of sheets together and separable by manual force.

3. The glue trap of claim 2, wherein the central opening extends through the stack of sheets.

4. The glue trap of claim 1, further comprising a series of perforations or a slit extending from the central opening to an outer edge of the sheet.
